(19) United States
(12) Patent Application Publication
(10) Pub. No.: US 2013/0124155 A1
(43) Pub. Date: May 16, 2013

(54) Controlling Features In A Software Application Based on The Status of User Subscription

(71) Applicant: TRIMBLE NAVIGATION LIMITED, Sunnyvale, CA (US)

(72) Inventors: Tyler Miller, Denver, CO (US); John M. Bacus, Boulder, CO (US)

(73) Assignee: TRIMBLE NAVIGATION LIMITED, Sunnyvale, CA (US)

(21) Appl. No.: 13/676,335

(22) Filed: Nov. 14, 2012

Related U.S. Application Data
(60) Provisional application No. 61/559,969, filed on Nov. 15, 2011.

(51) Int. Cl. G06F 17/50

(52) U.S. Cl. CPC G06F 17/50
USPC 703/1

(57) ABSTRACT

Features of a 3D modeling software application are controlled based on a subscription status of a user. A user having an active subscription status is provided with 3D modeling functions that include functions for creating, inspecting, and modifying 3D models. If the user's subscription status changes to an expired status, the user is provided with at least one of the 3D modeling functions that was provided during the active subscription and is prevented from using at least one other of the 3D modeling functions that was provided during the active subscription.

### CROSS REFERENCE TO RELATED APPLICATIONS

This application claims the benefit of U.S. Provisional Patent Application No. 61/559,969, filed on Nov. 15, 2011, entitled “Controlling Features in a Software Application Based on the Status of User Subscription,” the disclosure of which is hereby expressly incorporated herein by reference.

### FIELD OF THE DISCLOSURE

The present disclosure relates to 3D modeling systems, and more specifically to a 3D modeling system that controls features of a 3D modeling software application based on the status of the user's subscription.

### BACKGROUND

The background description provided herein is for the purpose of generally presenting the context of the disclosure. Work of the presently named inventors, to the extent that work is described in this background section, as well as aspects of the description that may not otherwise qualify as prior art at the time of filing, are neither expressly nor impliedly admitted as prior art against the present disclosure.

Today, professional as well as non-professional users in a variety of different fields, such as engineering, architecture, automotive design, graphic design, advertising, fashion design, medicine, etc., can develop three-dimensional (3D) models of buildings, vehicles, and other objects using 3D modeling software that operates on a computing device. A user typically interacts with 3D modeling software via an input device such as a keyboard, mouse, trackball and/or stylus, and the drafting document is displayed on a graphical display device, such as a computer monitor or screen.

3D modeling software typically allows a user to create a 3D model by drawing various 3D objects (directly or by defining two-dimensional faces that make up 3D objects) and by applying colors and/or textures to surfaces of the objects. The software may provide the user with stock objects or components such as spheres, polyhedrons, and other known geometric 3D objects, and/or provides tools to create such objects. Additionally or alternatively, the software may provide stock two-dimensional shapes (e.g., triangles, circles, quadrilaterals) and/or tools to create two-dimensional shapes for drawing projections of a 3D model onto planes. Moreover, the software typically allows a user to view a rendering of a 3D model, and to interactively view the 3D model (e.g., by magnifying, panning across, or rotating the entire 3D model, or by “orbiting” the entire 3D model about a certain line or point). Further, the software typically includes editing functions that allow a user to modify a 3D model (e.g., by resizing, rotating, or changing the shape of objects within the 3D model, by changing colors and/or textures of surfaces of objects within the 3D model, and/or by redefining interactions between objects within the 3D model). Many computer operations required by 3D modeling software are complex and computationally intensive operations that involve, for example, computations in analytic geometry.

Today, various software companies offer 3D modeling software as an executable that is compatible with one or more particular platforms such as the Windows XP operating system, for example. An executable may be provided on a computer-readable medium (e.g., a compact disc) purchased by a user, for example. To begin a 3D modeling session that provides the user with 3D modeling functionality, a user must install the 3D modeling software on a computing device (e.g., a personal computer) and launch the 3D modeling software application.

### SUMMARY

In an embodiment, a method for controlling features of a 3D modeling software application is implemented in a computer. The method includes automatically determining, at a first time, that a subscription status of a user corresponds to an active status, causing an inspection function, a modification function, and a creation function to be provided, via an interface of a computing device, to the user for activation in response to determining that the subscription status corresponds to the active status, automatically determining, at a second time subsequent to the first time, that the subscription status of the user corresponds to an expired status, and, in response to determining that the subscription status corresponds to the expired status, causing at least one of the inspection function, the modification function, and the creation function to be provided to the user for activation and causing at least a different one of the inspection function, the modification function, and the creation function to be made unavailable to the user at the computing device. The inspection function is for interpreting existing modeling data to view a corresponding existing 3D model, the modification function is for modifying the existing modeling data to modify the corresponding existing 3D model, and the creation function is for creating new modeling data that corresponds to a new 3D model.

In another embodiment, a tangible non-transitory computer-readable medium stores a plurality of instructions for controlling features of a 3D modeling software application. The plurality of instructions includes instructions for determining, at a first time, that a subscription status of a user corresponds to an active status, causing an inspection function, a modification function, and a creation function to be provided, via an interface of a computing device, to the user for activation in response to determining that the subscription status corresponds to the active status, determining, at a second time subsequent to the first time, that the subscription status of the user corresponds to an expired status, and, in response to determining that the subscription status corresponds to the expired status, causing at least one of the inspection function, the modification function, and the creation function to be provided to the user for activation and causing at least a different one of the inspection function, the modification function, and the creation function to be made unavailable to the user at the computing device. The inspection function is for interpreting existing modeling data to view a corresponding existing 3D model, the modification function is for modifying the existing modeling data to modify the corresponding existing 3D model, and the creation function is for creating new modeling data that corresponds to a new 3D model.

In another embodiment, a method for controlling access of a user to features of a 3D modeling software application executing on one or more processors of a computing device that is communicatively coupled to a server by a communication network is implemented in the server. The method includes receiving via the communication network a first request for permissions data, automatically determining, at a first time, that a subscription status of the user corresponds to an active status, causing first permissions data to be transmitted to the computing device via the communication network in response to receiving the first request and determining that the subscription status corresponds to the active status, receiving via the communication network a second request for permissions data, automatically determining, at a second time subsequent to the first time, that the subscription status of the user corresponds to an expired status, and, in response to receiving the second request and determining that the subscription status corresponds to the expired status, causing second permissions data to be transmitted to the computing device via the communication network. The first permissions data causes the 3D modeling software application to provide, via an interface of the computing device, an inspection function, a modification function, and a creation function to the user for activation. The second permissions data causes the 3D modeling software application to provide to the user for activation at least one of the inspection function, the modification function, and the creation function, and make unavailable to the user at the computing device at least a different one of the inspection function, the modification function, and the creation function. The inspection function is for interpreting existing modeling data to view a corresponding existing 3D model, the modification function is for modifying the existing modeling data to modify the corresponding existing 3D model, and the creation function is for creating new modeling data that corresponds to a new 3D model.

### BRIEF DESCRIPTION OF THE DRAWINGS

FIG. 1 is a block diagram of a communication system in which techniques for controlling features in a 3D modeling software application based on a user's subscription status can be applied;

FIG. 2 is a flow diagram of an example method for controlling 3D modeling features based on a user's subscription status that may be implemented in one or more servers or a user's computing device operating in the communication system of FIG. 1;

FIG. 3 is a flow diagram of another example method for controlling 3D modeling features based on a user's subscription status that may be implemented in one or more servers or a user's computing device operating in the communication system of FIG. 1;

FIG. 4 is a table of an example correlation between user subscription status and permissions for 3D modeling function sets that may be represented by data stored in one or more servers or a user's computing device operating in the communication system of FIG. 1;

FIG. 5 is a flow diagram of an example method for controlling 3D modeling features based on a user's subscription status including a post-expiration period that may be implemented in one or more servers or a user's computing device operating in the communication system of FIG. 1;

FIG. 6 is a flow diagram of another example method for controlling 3D modeling features based on a user's subscription status including a post-expiration period that may be implemented in one or more servers or a user's computing device operating in the communication system of FIG. 1;

FIG. 7 is a flow diagram of an example method for providing 3D modeling features to a user based on permissions data that may be implemented in a user's computing device operating in the communication system of FIG. 1; and

FIG. 8 is a flow diagram of an example method for controlling 3D modeling features by generating permissions data corresponding to a user subscription status that may be implemented in one or more server's operating in the communication system of FIG. 1.

### DETAILED DESCRIPTION

In embodiments described below, a 3D modeling system controls features of a 3D modeling software application based on a user's subscription status. The subscription may be offered by the provider of the 3D modeling software application in exchange for the user's payment and/or agreement to terms of service, for example. When the user's subscription is active, some or all features of the 3D modeling software application may be provided to the user. When the user's subscription subsequently expires, the user may be provided with a reduced set of features that includes some, but not all, of the 3D modeling features provided during the active subscription period. A user with an active status (e.g., a status indicating an active full or trial subscription) may be provided with 3D modeling features in the form of 3D modeling functions or sets of related functions (as used herein, the term “function” may refer to a certain amount of functionality at any level of granularity, as well as any level of nesting of a function within other functions). The 3D modeling functions may include, for example, functions for creating, viewing, and modifying 3D models, and, in some embodiments, functions for exporting a 3D model to a different application and/or collaboratively developing a 3D model with another user. If the user's status subsequently changes to an expired status, the user may retain access to at least one of the 3D modeling functions, but lose access to at least one other 3D modeling functions.

Moreover, in some embodiments, some or all of the function sets retained after the user's subscription has expired are only provided to the user with respect to 3D models that the user created while having an active subscription. For example, a user whose subscription has expired may retain the ability to view and modify 3D models that he or she had created during the subscription period, but lose the ability to create new 3D models. In some embodiments, the post-subscription, reduced set of features is provided to the user indefinitely, and in other embodiments the reduced set of features is provided to the user for only a predetermined length of time. For example, the reduced set of features may be provided to the user indefinitely if the subscription was a paid, full subscription prior to expiring. As another example, the reduced set of features may be provided to the user for only a predetermined length of time (30 days, 1 year, etc.) if the subscription was a free or lower-cost trial subscription prior to expiring.

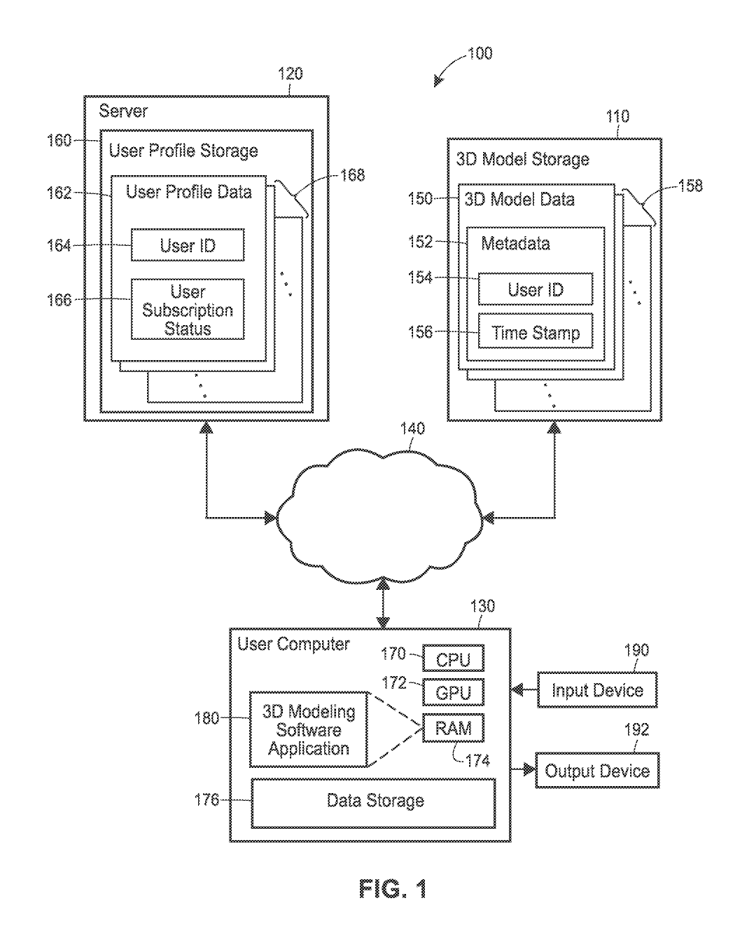

FIG. 1 is a block diagram of a communication system 100 in which techniques for controlling features in a 3D modeling software application based on a user's subscription status can be applied. In an embodiment, the communication system 100 includes a 3D model storage 110, a server 120, and a user computer 130, each of which is communicatively coupled to a communication network 140. The communication network 140 may include an Ethernet, for example, or any combination of one or more local area networks (LANs) and/or wide area networks (WANs) such as the Internet.

The 3D model storage 110 may store 3D model data 150 on a computer-readable medium with persistent memory such as a hard disk drive or an optical disk, for example. The 3D model data 150 represents a 3D model and is stored in a predefined, non-image format compatible with a 3D modeling software application. Unlike data in an image format (e.g., raster image data), which may allow static display of the corresponding image or simple, two-dimensional viewing operations such as magnification or panning, the 3D model data 150 allows much greater interaction with the 3D model that the 3D model data 150 represents. For example, the 3D model data 150 may be manipulated to change the viewpoint of the corresponding 3D model (i.e., the camera perspective from which the model is displayed) such that the 3D model appears to rotate or orbit in three dimensions (i.e. rotate or orbit about a line that is not orthogonal to the display plane). As another example, the 3D model data 150 may be manipulated to modify the corresponding 3D model by changing properties (size, shape, color, texture, orientation, etc.) of a certain object within the 3D model independently of other objects within the model. More specifically, a user may resize, remove, add, re-texture, etc. basic components of the 3D model such as hexahedrons, tetrahedrons, or spheres, as well as composite components of the 3D model such as groups of two or more basic components. As another example, the 3D model data 150 may be manipulated to modify interactions between various objects within the corresponding 3D model. In some embodiments, the 3D model storage 110 is a part of a server communicatively coupled to the communication network 140, such as the server 120. In other embodiments, the 3D model storage 110 may be a part of the user computer 130.

The 3D model data 150 may include metadata 152 that represents information about the 3D model data 150. For example, the metadata 152 may include a user ID 154 representing some indicium (account number, name, etc.) that corresponds to a particular user that created the 3D model represented by the 3D model data 150. As another example, the metadata 152 may include a time stamp 156 representing a time, day, etc. on which the 3D model data 150 was originally created and/or last modified. The 3D model storage 110 may, in some embodiments, store additional 3D model data 158 that represents one or more additional 3D models.

The server 120 may include a user profile storage 160 that is a computer-readable medium with persistent memory such as a hard disk drive or an optical disk, for example. The user profile storage 160 may store user profile data 162, which includes information about a particular user of a 3D modeling software application. For example, the user profile data 162 may include a user ID 164 representing some indicium (account number, etc.) that uniquely identifies a particular user of the 3D modeling software. Where a user associated with the user profile data 162 is the same user that created the 3D model represented by the 3D model data 150, for example, the user ID 164 stored in the user profile storage 160 may be the same as the user ID 154 stored in the 3D model storage 110. As another example, the user profile data 162 may include data (not shown) representing the number of 3D models created by the user associated with the user ID 164, and/or the amount of memory used by those 3D models.

As another example, the user profile data 162 may include a user subscription status 166 representing a current subscription status of a user of the 3D modeling software application. For example, the user subscription status 166 may be set to indicate an active subscription or an expired subscription. In some embodiments, the user subscription status 166 may represent one of a broader variety of subscriptions. For example, the user subscription status 166 may at any given time correspond to one of an active full subscription, an active trial subscription, an expired full subscription, and an expired trial subscription. A trial subscription may reflect that a user has agreed to terms of service (possibly including payment of a relatively low fee) in exchange for use of the 3D modeling software application for a first amount of time, for example. A full subscription may reflect that a user has agreed to terms of service (including payment of a fee) in exchange for use of the 3D modeling software application for a second amount of time, for example. In some embodiments, the user subscription status 166 may also reflect whether a post-expiration period of limited duration has expired. An active post-expiration period status may reflect that a full or trial subscription has expired and a predetermined time period immediately following the subscription has not expired.

The user subscription status 166 may change over time as the subscription status of the user corresponding to the user ID 164 changes (e.g., based on the example conditions for a full or trial subscription described above). For example, the user subscription status 166 may reflect an active subscription at a first time and an expired subscription at a second time subsequent to the first time. As another example, the user subscription status 166 may reflect an active trial subscription at a first time, an active full subscription at a second time subsequent to the first time, and an expired full subscription at a third time subsequent to the second time. As yet another example, the user subscription status 166 may reflect an active trial subscription at a first time, an expired trial subscription at a second time subsequent to the first time, and an expired post-trial period at a third time subsequent to the second time.

The user profile storage 160 may include only a single user's profile data (e.g., the user profile data 162), or may include additional user profile data 168 that includes information about additional users of the 3D modeling software application. The server 120 may be one or more computing devices and may have a network interface (not shown) that allows the server to transmit and receive data over the communication network 140 (including data sent to and from the user computer 130), for example. To accurately track the current state of a user's subscription, the server 120 may in some embodiments automatically update the user subscription status 166 periodically or otherwise by checking conditions relating to the subscription status. For example, the server 120 may determine whether a user has indicated agreement to the terms of service of a subscription by having chosen a particular option presented by a web page, or may determine whether a predetermined length of time has elapsed since a user's subscription began. In some embodiments, the server 120 updates the user subscription status 166 by checking conditions relating to the subscription status in response to a request from the user computer 130. In other embodiments, an operator may use the server 120 or another computing device to manually update the user subscription status 166. In some embodiments, the server 120 also includes the 3D model storage 110.

The user computer 130 in some embodiments includes a central processing unit (CPU) 170 to execute computer-readable instructions, a graphics processing unit (GPU) 172 to execute certain computer-readable instructions relating to graphics, a random access memory (RAM) unit 174 to store data and instructions during operation of programs, and a data storage 176 that includes persistent memory to store data used by the programs executed by CPU 170. By way of example, the data storage 176 may be implemented on a hard disk drive coupled to the CPU 170 via a bus (not shown). Generally speaking, the components 170, 172, 174, and 176 may be implemented in any suitable manner. Although the user computer 130 in the example of FIG. 1 is a personal computer (PC), the user computer 130 may be any suitable stationary or portable computing device, such as a tablet PC or a smart phone, for example. Moreover, although the user computer 130 in the example of FIG. 1 includes both storage and processing components, the user computer 130 in other embodiments can be a so-called “thin” client that depends on another computing device for certain computing and/or storage functions. For example, in some embodiments, the data storage 176 is external to the user computer 130 and is connected to the user computer 130 via a network link. The user computer 130 may include a network interface (not shown) that allows the user computer 130 to transmit and receive data over the communication network 140 (including data sent to and from the server 120), for example.

In some embodiments, the data storage 176 includes a copy of the 3D model data 150. The copy may be a local copy of the 3D model data 150 that the user computer 130 generated after accessing the 3D model data 150 through a web page that stores or references the 3D model data 150, for example. In other embodiments, the 3D model data 150 itself may be stored in the data storage 176 of the user computer 130.

The user computer 130 may be coupled to an input device 190 that allows the user to enter inputs to the user computer 130 and an output device 192 that allows the user to view outputs/displays from the user computer 130. The input device 190 may be a pointing device such as a mouse, keyboard, touch screen, trackball device, digitizing tablet, or microphone, for example. The output device 192 may be an LCD display monitor or a touch screen, for example. Using the input device 190 and the output device 192, a user can interact with a graphical user interface (GUI) of the user computer 130.

In some embodiments, a 3D modeling software application may be stored as an executable in a program storage (not shown) on the user computer 130. In other embodiments, a 3D modeling software application may be browser-based. To this end, a web browser application may be stored in a program storage on the user computer 130, for example. The web browser application may execute on the CPU 170, for example. In operation, a user operating the user computer 130 via the input device 190 may use the web browser application to access one or more web pages via the communication network 140. In one embodiment, a browser-based 3D modeling software application may include instructions that are stored in or referenced by the one or more web pages. The web browser may interpret the instructions at runtime to execute the 3D modeling software application, for example. As a more specific example, the 3D modeling software may include scripting language (e.g., JavaScript) instructions that are stored in the one or more web pages. In another embodiment, a browser-based 3D modeling software application may include compiled instructions that are referenced by the one or more web pages. The compiled instructions may be downloaded and installed on the user computer 130 in order for the web browser to execute the 3D modeling software application (or to execute certain functionality within the 3D modeling software application), for example. The compiled instructions may be included in a plugin available via one of the web pages, for example. In some embodiments, a browser-based 3D modeling software application may include one or more software components with instructions that are interpretable at runtime and one or more software components with instructions that are compiled. For example, a first software component may consist of scripting language instructions and a second software component may be a plugin. The software component(s) of a browser-based 3D modeling software application may be stored in a server that stores the one or more web pages, for example, or may be stored in a separate server at one or more locations referenced by at least one of the web pages. The software component(s) of the browser-based 3D modeling software application may be stored in a memory disposed within the server 120, for example.

When the CPU 170 executes the 3D modeling software application (e.g., when a user launches a 3D modeling software executable installed on the user computer 130, or when the user's web browser application executes browser-based 3D modeling software), the RAM unit 174 may temporarily store the instructions and data required for execution of the 3D modeling software application. FIG. 1 illustrates a 3D modeling software application 180 disposed in the RAM unit 174 during execution. The 3D modeling software application 180 may, when executed, provide a 3D modeling GUI that is displayed to the user on the output device 192, and the 3D modeling GUI may present to the user 3D modeling commands that the user may select using the input device 190. In the case of browser-based 3D modeling software, the 3D modeling GUI may be displayed to the user within a GUI of a web browser, for example.

When executing, the 3D modeling software application 180 may provide to a user various 3D modeling functions that may be categorized as distinct sets of functions. One example set of 3D modeling functions may allow the user to view or inspect an existing 3D model (represented by the 3D model data 150) from various viewpoints. Functions within this function set may include functions for interpreting 3D model data 150 (or other 3D model data) to render the corresponding 3D model, magnifying, panning across, and/or rotating an entire 3D model, for example, and/or orbiting an entire 3D model about a certain line or point. Functions within this function set may relate only to rendering and representation of a 3D model, for example, without modifying the 3D model data 150 of the 3D model (other than, potentially, the metadata 152 associated with the 3D model data 150). For convenience, the functions in this set may be collectively referred to as the “inspection function.”

Another example set of 3D modeling functions may allow the user to modify an existing 3D model (represented by the 3D model data 150) in various ways. Functions within this function set may include functions for resizing, rotating, and changing the shape of objects within the 3D model, functions for adding objects to the 3D model, functions for removing objects from the 3D model, functions for changing colors or textures of surfaces of objects within the 3D model, and/or functions for defining or redefining interactions between objects within the 3D model, for example. The objects on which these functions operate may be basic components of the 3D model (e.g., hexahedrons, tetrahedrons, spheres, and other components that are provided by the 3D modeling software application 180 via a toolbar or a pane, according to some embodiments) or composite components that include multiple basic components. Functions within this function set may modify the 3D model data 150 of a 3D model (apart from any modification of the metadata 152, which may or may not also be modified by execution of these functions), for example, without changing the format of the 3D model data 150. For convenience, this set of 3D modeling functions may be referred to simply as the “modification function.”

Further, another example set of 3D modeling functions may allow the user to create a new 3D model, thereby generating a new set of 3D model data similar to the 3D model data 150. Functions within this function set may include functions for creating a new 3D model “from scratch” (i.e., where the new 3D model is empty until modified by adding objects, etc.), and/or saving an existing 3D model as a new 3D model under a new name, for example. These functions may be collectively referred to as the “creation function.”

Yet another example set of 3D modeling functions may allow the user to export an existing 3D model to another software application. Functions within this function set (which also may be referred to as the “exporting function”) may include a function for converting the 3D model data 150 to a different format of a different software application, for example. As an example, the 3D model data 150 may be converted to the format of a presentation application such that the 3D model (represented by the 3D model data 150) may be included in one or several slides within a presentation created using the presentation application. In some embodiments, the exporting function simply converts the 3D model data 150 to an image (e.g., raster) format.

In some embodiments, the 3D modeling software application 180 may also include a collaborative development feature with a function set that allows users operating different computing devices to jointly develop a 3D model substantially in real-time. To this end, the user computer 130 may be communicatively coupled to another user's computer (not shown) via a network such as the communication network 140. Functions within this function set (which also may be referred to as the “collaborative development function”) may include a function that allows a user at the user computer 130 to enter a command that changes a viewpoint corresponding to the rendering of a 3D model (such as the 3D model represented by the 3D model data 150) at a different user's computer, for example, or that modifies the 3D model as it is being viewed at a different user's computer.

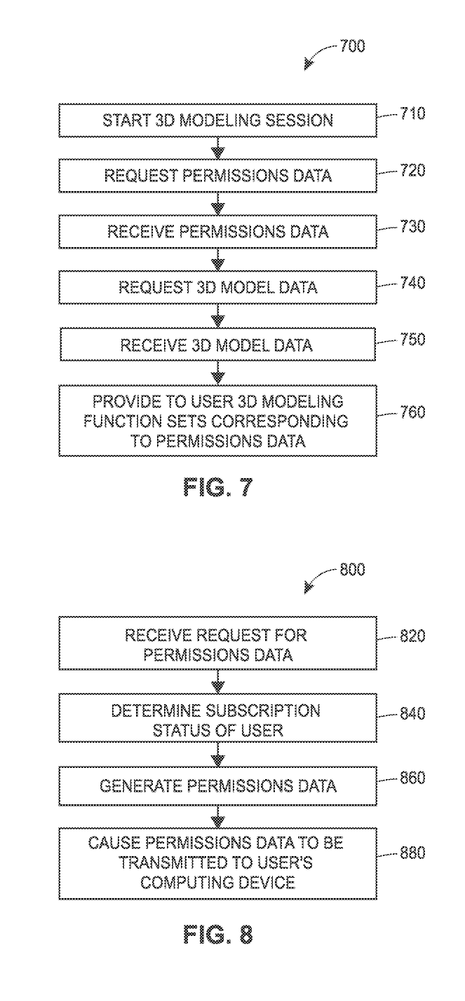

In operation, a user may launch a session of the 3D modeling software application 180 at the user computer 130, where the application 180 may be a locally-installed executable or browser-based software as discussed above. In some embodiments, and as discussed in more detail below in connection with FIG. 7, the 3D modeling software application 180 generates a request for subscription and/or permission information in response to the launching of the application 180. The 3D modeling software application 180 may then cause the user computer 130 to transmit the request for subscription and/or permission information to the server 120 via the communication network 140.

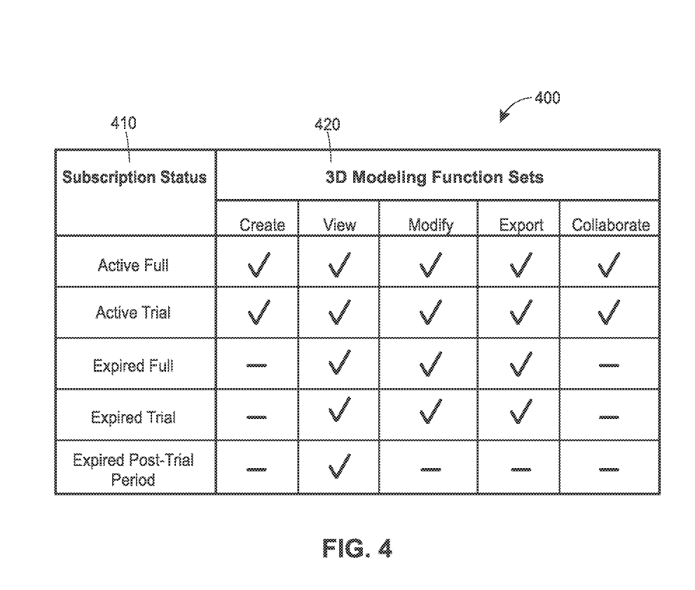

In response to receiving the request for subscription and/or permission information, the server 120 may retrieve the user subscription status 166. In some embodiments, the server 120 may then transmit the user subscription status 166 to the user computer 130 via the communication network 140. As discussed above, the user subscription status 166 may include data that reflects the current state of a user's subscription. Accordingly, in some embodiments, the user computer 130 (e.g., via instructions in the 3D modeling software application 180) may use the received user subscription status 166 to generate permissions data identifying which 3D modeling function sets should be provided to the user and which 3D modeling function sets should be made unavailable to the user. To this end, the user computer 130 may store or otherwise have access to data (e.g., data of a relational database) that defines a correlation between subscription status and 3D modeling functionality, such as the correlation portrayed in the example embodiment of FIG. 4 discussed below. The 3D modeling software application 180 may then start the 3D modeling session on the user computer 130 and provide certain sets of 3D modeling functions to the user (and, in some instances, make certain other sets of 3D modeling functions unavailable to the user) based on the permissions data. The user computer 130 may update the permissions data (e.g., generate new permissions data) each time the user computer 130 receives the user subscription status 166, for example.

In other embodiments, the server 120 (rather than the user computer 130) may use the user subscription status 166 to generate permissions data identifying which 3D modeling function sets should be provided to the user and which 3D modeling function sets should be made unavailable to the user. To this end, the server 120 may store or otherwise have access to the correlation data discussed above. The server 120 may then transmit the generated permissions data to the user computer 130 via the communication network 140. The 3D modeling software application 180 may then start the 3D modeling session on the user computer 130 and provide certain sets of 3D modeling functions to the user (and, in some instances, make certain other sets of 3D modeling functions unavailable to the user) based on the permissions data. The server 120 may update the permissions data (e.g., generate new permissions data) in response to a change in the user subscription status 166, for example. As another example, the server 120 may update the permissions data each time the server 120 receives a request for the permissions data (e.g., from the user computer 130).

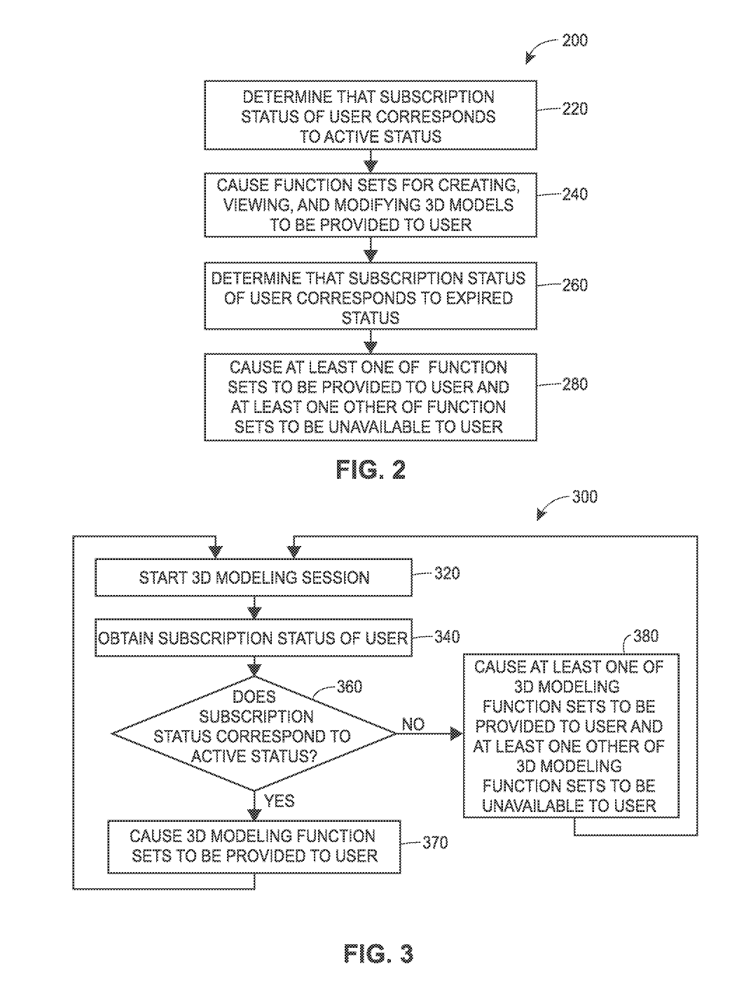

Next, example methods are discussed with reference to FIGS. 2 and 3. The methods may be implemented in the communication system 100 of FIG. 1, or in a similar environment, to control features in a 3D modeling software application based on a user's subscription status. In general, the methods of FIGS. 2 and 3 may be stored as instructions on a computer-readable medium and may be implemented using any suitable programming language. In some embodiments, the methods of FIGS. 2 and 3 may be stored as instructions that are a part of a 3D modeling software application, such as the 3D modeling software application 180 of FIG. 1. The instructions in the methods of FIGS. 2 and 3 may execute on one or several processors.

FIG. 2 is a flow diagram of an example method 200 for controlling 3D modeling features based on a user's subscription status. The method 200 of the flow diagram illustrated in FIG. 2 may be implemented in one or more servers, such as the server 120 of FIG. 1, or in a user's computing device such as the user computer 130 of FIG. 1, and will be described with reference to FIG. 1 for illustrative purposes. The method 200 may, however, be implemented by other suitable computing devices. In some embodiments, the method of FIG. 2 may be stored as instructions that are a part of a 3D modeling software application, such as the 3D modeling software application 180 of FIG. 1.

At block 220, it is determined at a first time that a subscription status of a user corresponds to an active status. As used herein, the “first time” may refer to a single moment, to a continuous range of time, or to multiple, non-continuous time ranges. In some embodiments, it is determined that the subscription status of the user corresponds to a specific type of active status (active full status, active trial status, etc.). In some embodiments, a user's computing device may determine that the subscription status of the user corresponds to an active status. For example, the user computer 130 executing the 3D modeling software application 180 may determine that the user subscription status 166 corresponds to an active status by generating a hypertext transfer protocol (HTTP) request, transmitting that request via the communication network 140 to the server 120, and receiving in response to the request the user subscription status 166.

In other embodiments, a server may determine that the subscription status of the user corresponds to an active status. For example, the server 120 may determine that the user subscription status 166 corresponds to an active status by determining that conditions corresponding to an active subscription status currently exist. The server 120 may determine that the user subscription status 166 corresponds to an active status by determining that the user had previously selected an option (e.g., by using a GUI of a web browser executing on the user computer 130) indicating that the user agreed to terms of service for a subscription, for example. As another example, the server 120 may determine that the subscription status 166 corresponds to an active status by determining that the user had previously selected an option indicating that the user agreed to terms of service for a subscription and that a predetermined length of time has not expired. In other embodiments, the server 120 may determine the user subscription status 166 by retrieving the user subscription status 166 from an external source, such as another server (e.g., in response to a request from the server 120). In some embodiments, the server 120 may determine the user subscription status 166 in response to receiving the request (e.g., the HTTP request) from the user computer 130. In other embodiments, the server 120 may determine the user subscription status 166 prior to receiving a request from the user computer 130.

At block 240, 3D modeling function sets including function sets for creating, viewing/inspecting, and modifying 3D models are caused to be provided to the user in response to determining at block 220 that the user's subscription status corresponds to an active status. In some embodiments, the 3D modeling functions sets also include a function set for exporting a 3D model to a different software application, and/or a function set for collaboratively developing a 3D model with a different user at a different computing device. In embodiments where a user's computing device determines (at block 220) that the subscription status of the user corresponds to an active status, the user's computing device may also cause the 3D modeling function sets to be provided to the user. For example, the user computer 130 executing the 3D modeling software application 180 may, in response to the determination at block 220, cause the 3D modeling function sets to be provided to the user. In some embodiments, the user computer 130 causes the 3D modeling function sets to be provided to the user at least in part by generating permissions data, such as the permissions data discussed above in connection with FIG. 1.

The permissions data may include flags or fields associated with the function sets (or associated with individual functions within the function sets), for example. The 3D modeling software application 180 may then check those data flags or fields to determine that the function sets (e.g., function sets for creating, viewing, and modifying 3D models) should be provided to the user. For example, the instructions of the application 180 may include conditional logic that, when the data flags or fields of the permissions data are set to particular values, presents commands for the corresponding 3D modeling functions or function sets in a 3D modeling GUI displayed to the user (e.g., via the output device 192), and executes instructions for carrying out those commands when the user selects the commands on the GUI (e.g., via the input device 190).

In embodiments where a server determines (at block 220) that the subscription status of the user corresponds to an active status, the server may also cause the 3D modeling function sets to be provided to the user. For example, the server 120 may, in response to the determination at block 220, cause the 3D modeling function sets to be provided to the user at least in part by generating permissions data similar to the permission data discussed above, and then transmitting the permissions data to the user computer 130 via the communication network 140. The 3D modeling software application 180 may then use the permissions data to provide function sets (e.g., function sets for creating, viewing, and modifying 3D models) to the user in a manner similar to that discussed above.

In some embodiments, permissions data (whether generated by a server such as the server 120 or a user's computing device such as the user computer 130) further includes data indicating that certain 3D modeling function sets may be provided to a user only in relation to particular 3D models. For example, the permissions data may include data indicating that the user may only modify and/or export 3D models that the user created, or may only modify and/or export 3D models that the user created while the user's subscription was active.

In some embodiments, some or all of the 3D modeling function sets provided to the user at block 240 are only provided to the user with respect to a predetermined, threshold number of 3D models associated with the user. For example, the 3D modeling software application 180 may prevent a user from creating a new 3D model if the user has already created a threshold number of 3D models, even if the user subscription status 166 is still an active status. In some embodiments, some or all of the 3D modeling function sets provided to the user at block 240 are only provided to the user with respect to a predetermined, threshold amount of memory used to store 3D models associated with the user. For example, the application 180 may prevent a user from creating a new 3D model if it is determined that the new 3D model would cause a threshold amount of storage space (e.g., in the 3D model storage 110) to be exceeded, even if the user subscription status 166 is still an active status.

At block 260, it is determined at a second time subsequent to the first time that the subscription status of the user corresponds to an expired status. As used herein, the “second time” may refer to a single moment, to a continuous range of time, or to multiple, non-continuous time ranges. In some embodiments, it is determined that the subscription status of the user corresponds to a specific type of expired status (expired full status, expired trial status, etc.). The determination may be made in a manner similar to the determination at block 220, for example, although at a later time and with a different result (i.e., an expired status rather than an active status).

At block 280, at least one of the 3D modeling function sets (initially caused to be provided at block 240) is again caused to be provided to the user, and at least one other of those 3D modeling function sets is caused to be made unavailable to the user, in response to determining at block 260 that the user's subscription status corresponds to an expired status. In embodiments where a user's computing device determines (at block 260) that the subscription status of the user corresponds to an expired status, the user's computing device may also cause at least one of the 3D modeling function sets to be provided to the user and cause at least one other of the 3D modeling function sets to be made unavailable to the user. For example, the user computer 130 executing the 3D modeling software application 180 may, in response to the determination at block 260, generate permissions data similar to the permissions data discussed above in connection with block 240. The application 180 may then check the permissions data to determine which 3D modeling function sets should be provided to the user and which 3D modeling function sets should be made unavailable to the user. For example, the instructions of the application 180 may include conditional logic that checks the permissions data. If the permissions data indicates that a particular function or function set should be provided to the user, the application 180 may present the commands for the function or function set in the 3D modeling GUI, and execute instructions associated with the commands when the user selects the commands on the GUI. If the permissions data indicates that a particular function or function set should be made unavailable to the user, the application 180 may not present the commands for the function or function set in the 3D modeling GUI, or may present the commands but not execute instructions associated with the commands when the user selects the commands on the GUI. In some embodiments, the application 180 may “gray out” GUI commands corresponding to functions that are made unavailable to the user so that the user may easily determine which 3D modeling functionality is currently unavailable.

In embodiments where a server determines (at block 260) that the subscription status of the user corresponds to an expired status, the server may also cause at least one of the 3D modeling function sets to be provided to the user and cause at least one other of the 3D modeling function sets to be made unavailable to the user. For example, the server 120 may, in response to the determination at block 260, generate permissions data similar to the permissions data discussed above in connection with block 240, and then transmit the permissions data to the user computer 130 via the communication network 140. The 3D modeling software application 180 may then use the permissions data to provide the at least one function set to the user and make the at least one other function set unavailable to the user in a manner similar to that discussed above.

In some embodiments, the 3D modeling function sets caused to be provided to the user at block 280 include the function set for viewing an existing 3D model and the function set for modifying an existing 3D model, and the 3D modeling function sets caused to be made unavailable to the user at block 280 include the function set for creating a new 3D model.

FIG. 3 is a flow diagram of another example method 300 for controlling 3D modeling features based on a user's subscription status. The method 300 of the flow diagram illustrated in FIG. 3 may be implemented in one or more servers, such as the server 120 of FIG. 1, or in a user's computing device such as the user computer 130 of FIG. 1, and will be described with reference to FIG. 1 for illustrative purposes. The method 300 may, however, be implemented by other suitable computing devices. In some embodiments, the method of FIG. 3 may be stored as instructions that are a part of a 3D modeling software application, such as the 3D modeling software application 180 of FIG. 1.

At block 320, a 3D modeling session is started. From the perspective of the user computer 130, the start of the 3D modeling session may in some embodiments occur in response to a user entering one or more commands via a user interface (UI) of the user's computing device, where the UI is a software component that receives and processes commands from a user (e.g., commands entered using the input device 190 of FIG. 1) and outputs to the user (e.g., information displayed on the output device 192 of FIG. 1). For example, the start of the 3D modeling session may represent the launching of the 3D modeling software application 180 in response to a user command to start the application 180. As another example, the start of the 3D modeling session may represent a user working on (e.g., viewing and/or modifying) a second 3D model using the application 180 after having worked on a first 3D model using the application 180, where the new session begins in response to the user selecting the second 3D model. From the perspective of the server 120, the start of the 3D modeling session may represent the reception of a data message (e.g., a data message received from the user computer 130 via the communication network 140) that indicates or requests permission for the launching of the 3D modeling software application 180 and/or a user's attempt to begin working on a second 3D model, for example.

At block 340, a subscription status of a user is obtained. In some embodiments, a user's computing device may obtain the subscription status of the user. For example, the user computer 130 executing the 3D modeling software application 180 may obtain the user subscription status 166 by generating an HTTP request, transmitting that request via the communication network 140 to the server 120, and receiving in response to the request the user subscription status 166. In other embodiments, a server may obtain the subscription status of the user. For example, the server 120 may obtain the user subscription status 166 by transmitting a request to another server and receiving the user subscription status 166 in response, or by checking a memory within the server 120 such as the user profile storage 166.

At block 360, it is determined whether the subscription status obtained at block 340 corresponds to an active status. For example, the server 120 or the user computer 130 may execute instructions for determining whether the user subscription status 166 corresponds to an active status. If it is determined that the subscription status obtained at block 340 corresponds to an active status, the flow proceeds to block 370. If it is determined that the subscription status obtained at block 340 does not correspond to an active status, the flow proceeds to block 380.

At block 370, 3D modeling function sets that include function sets for creating, viewing, and modifying 3D models are caused to be provided to the user in response to determining at block 360 that the user's subscription status corresponds to an active status. In some embodiments, the 3D modeling functions sets also include a function set for exporting a 3D model to a different software application, and/or a function set for collaboratively developing a 3D model with a different user at a different computing device. The 3D modeling function sets may be caused to be provided to the user in a manner similar to that described above in connection with block 240 of FIG. 2, for example. Subsequent to the block 370, the flow proceeds back to block 320, where the process of the method 300 repeats in response to the start of a new 3D modeling session. In some embodiments, the flow may instead proceed to block 340 after a predetermined length of time, i.e., the steps of blocks 340, 360 and either 370 or 380 may repeat periodically while a 3D modeling session is in effect, without requiring that the user end a first 3D modeling session and begin a second 3D modeling session.

In some embodiments, some or all of the 3D modeling function sets provided to the user at block 370 are only provided to the user with respect to a predetermined, threshold number of 3D models associated with the user. For example, the 3D modeling software application 180 may prevent a user from creating a new 3D model if the user has already created a threshold number of 3D models, even if the user subscription status 166 is still an active status. In some embodiments, some or all of the 3D modeling function sets provided to the user at block 360 are only provided to the user with respect to a predetermined, threshold amount of memory used to store 3D models associated with the user. For example, the application 180 may prevent a user from creating a new 3D model if it is determined that the new 3D model would cause a threshold amount of storage space (e.g., in the 3D model storage 110) to be exceeded, even if the user subscription status 166 is still an active status.

At block 380, at least one of the 3D modeling function sets is again caused to be provided to the user, and at least one other of the 3D modeling function sets is caused to be made unavailable to the user, in response to determining at block 360 that the user's subscription status does not correspond to an active status (e.g., in response to determining that the user's subscription status corresponds to an expired status). The 3D modeling function sets may be caused to be provided or made unavailable to the user in a manner similar to that described above in connection with block 280 of FIG. 2, for example. Subsequent to the block 380, the flow proceeds back to block 320, where the process of the method 300 repeats in response to the start of a new 3D modeling session. In some embodiments, the flow may instead proceed to block 340 after a predetermined length of time, i.e., the steps of blocks 340, 360 and either 370 or 380 may repeat periodically while a 3D modeling session is in effect, without requiring that the user end a first 3D modeling session and begin a second 3D modeling session.

FIG. 4 is a table 400 of an example correlation between user subscription status and permissions for 3D modeling function sets. As illustrated in the example embodiment, a user's subscription status may correspond to one of a plurality of subscription status values 410. Each of those values corresponds to permissions for one or more 3D modeling function sets 420. Each check mark in the table 400 indicates that a particular 3D modeling function set should be provided to a user when the user has the corresponding subscription status, and each dash in the table 400 indicates that a particular 3D modeling function set should be made unavailable to a user when the user has the corresponding subscription status. The information contained in the table 400 may be represented by correlation data that the server 120 or the user computer 130 of FIG. 1 may use to generate permissions data similar to the permissions data described above. The correlation data may be manually updated by an operator when a provider of 3D modeling software wishes to change the terms of one or more subscription categories, for example. The correlation data may be stored in a persistent memory of a server, such as the server 120 of FIG. 1, or in a persistent memory of a user's computing device such as the user computer 130 of FIG. 1, for example. The correlation data may, however, be stored in memory of other suitable computing devices.

With continued reference to the example embodiment of FIG. 4, the subscription status 410 may be one of an active full status to reflect that a user currently has an active full subscription, an active trial status to reflect an active trial subscription, an expired full status to reflect an expired full subscription, an expired trial status to reflect an expired trial subscription (i.e., and active post-trial period), or an expired post-trial status to reflect an expired post-trial period. The 3D modeling function sets 420 include a function set for creating 3D models, a function set for viewing 3D models, a function set for modifying 3D models, a function set for exporting 3D models, and a function set for collaborative development of 3D models. In some embodiments, each of the 3D modeling function sets 420 corresponds to a distinct set of functions, similar to the function sets described above in connection with FIGS. 1-3.

With the permissions in the example embodiment of FIG. 4, a 3D modeling software application (e.g., the application 180) provides a user with the function set for creating 3D models, the function set for viewing 3D models, the function set for modifying 3D models, the function set for exporting 3D models, and the function set for collaborative development of 3D models while the user has an active full status. When the user's full subscription expires and the subscription status 410 changes from the active full status to the expired full status, the user is provided with the function sets for viewing, modifying and exporting 3D models, but is prevented from using the function sets for creating a new 3D model 440 and collaboratively developing a 3D model. For example, while a user may not be able to create any new models, he or she may retain the ability to view, modify and export 3D models that he or she developed while the full subscription was active. In some embodiments, the user may retain indefinitely this limited 3D modeling ability following expiration of a full subscription.

In the example embodiment of FIG. 4, an active trial subscription corresponds to the same 3D modeling functionality as an active full subscription, and an expired trial subscription corresponds to the same 3D modeling functionality as an expired full subscription. In the example embodiment, however, a post-trial period a limited, predetermined duration begins when the trial subscription expires (e.g., in response to the subscription status 410 changing from an active trial status to an expired trial status). When the user's post-trial period expires and the subscription status 410 changes from an expired trial status (i.e., an active post-trial period) to an expired post-trial period status, the function sets for creating, modifying, exporting, or collaboratively developing 3D models are all made unavailable to the user. Accordingly, in the example embodiment of FIG. 4, the user is allowed to modify and export 3D models that he or she created during a trial subscription for a limited amount of time (30 days, 1 year, etc.) following the expiration of the trial period, but not after. In some embodiments, the user may also be prevented from using the function set for viewing 3D models after the expiration of a post-trial period.

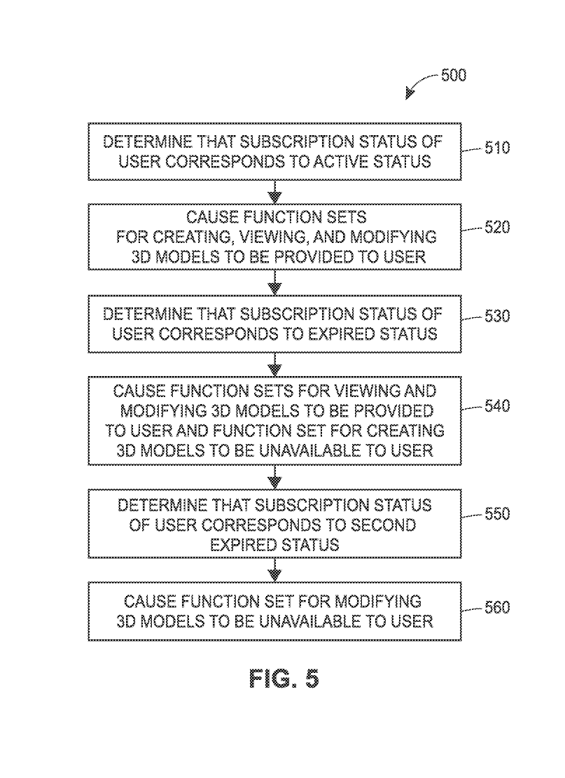

Next, example methods are discussed with reference to FIGS. 5-8. The methods may be implemented in the communication system 100 of FIG. 1, or in a similar environment, to control features in a 3D modeling software application based on a user's subscription status. In general, the methods of FIGS. 5-8 may be stored as instructions on a computer-readable medium and may be implemented using any suitable programming language. The instructions in the methods of FIGS. 5-8 may execute on one or several processors.

FIG. 5 is a flow diagram of an example method 500 for controlling 3D modeling features based on a user's subscription status including a post-expiration period (e.g., where a user may be associated with an active trial subscription status, an expired trial subscription status, or an expired post-trial period subscription status). The method 500 of the flow diagram illustrated in FIG. 5 may be implemented in one or more servers, such as the server 120 of FIG. 1, or in a user's computing device such as the user computer 130 of FIG. 1, and will be described with reference to FIG. 1 for illustrative purposes. The method 500 may, however, be implemented by other suitable computing devices. In some embodiments, the method of FIG. 5 may be stored as instructions that are a part of a 3D modeling software application, such as the 3D modeling software application 180 of FIG. 1.

At block 510, it is determined at a first time that a subscription status of a user corresponds to an active status. As used herein, the “first time” may refer to a single moment, to a continuous range of time, or to multiple, non-continuous time ranges. The subscription status may be determined in a manner similar to the determination of the subscription status at block 220 of FIG. 2, for example.

At block 520, 3D modeling function sets including function sets for creating, viewing, and modifying 3D models are caused to be provided to the user in response to determining at block 510 that the user's subscription status corresponds to an active status. In some embodiments, the 3D modeling functions sets also include a function set for exporting a 3D model to a different software application, and/or a function set for collaboratively developing a 3D model with a different user at a different computing device. The 3D modeling function sets may be caused to be provided to the user in a manner similar to that described above in connection with block 240 of FIG. 2, for example.

At block 530, it is determined at a second time subsequent to the first time that the subscription status of the user corresponds to an expired status. As used herein, the “second time” may refer to a single moment, to a continuous range of time, or to multiple, non-continuous time ranges. In some embodiments, it is determined that the subscription status of the user corresponds to a specific type of expired status (expired full status, expired trial status, etc.). The determination may be made in a manner similar to the determination at block 510, for example, although at a later time and with a different result (i.e., an expired status rather than an active status).

At block 540, the 3D modeling function sets for viewing and modifying 3D models (initially caused to be provided at block 520) are again caused to be provided to the user, and the 3D modeling function set for creating 3D models is caused to be made unavailable to the user, in response to determining at block 530 that the user's subscription status corresponds to an expired status. The 3D modeling function sets may be caused to be provided or made unavailable to the user in a manner similar to that described above in connection with block 280 of FIG. 2, for example.

At block 550, it is determined at a third time subsequent to the second time that the subscription status of the user corresponds to a second expired status. As used herein, the “third time” may refer to a single moment, to a continuous range of time, or to multiple, non-continuous time ranges. In some embodiments, it is determined that the subscription status of the user corresponds to a specific type of second expired status (expired post-trial period, etc.). The determination may be made in a manner similar to the determination at block 510 or block 530, although at a later, third time and with a different result (i.e., a second expired status rather than an active status or expired status). In some embodiments, the active status determined at block 510 is an active trial status corresponding to an active trial subscription, the expired status determined at block 530 is an expired trial status corresponding to the trial subscription having expired, and the second expired status determined at block 550 is an expired post-trial period status corresponding to a post-trial period having expired, where the post-trial period began in response to the end of the trial subscription. For example, a predetermined time limit (30 days, 1 year, etc.) of a post-trial period may be measured from the time when a trial subscription expires.

At block 560, the function set for modifying 3D models (caused to be provided to the user at block 520 and again at block 540) is caused to be made unavailable to the user, in response to determining at block 550 that the user's subscription status corresponds to a second expired status. The function set for modifying 3D models may be caused to be made unavailable to the user in a manner similar to that described above in connection with block 280 of FIG. 2, for example.

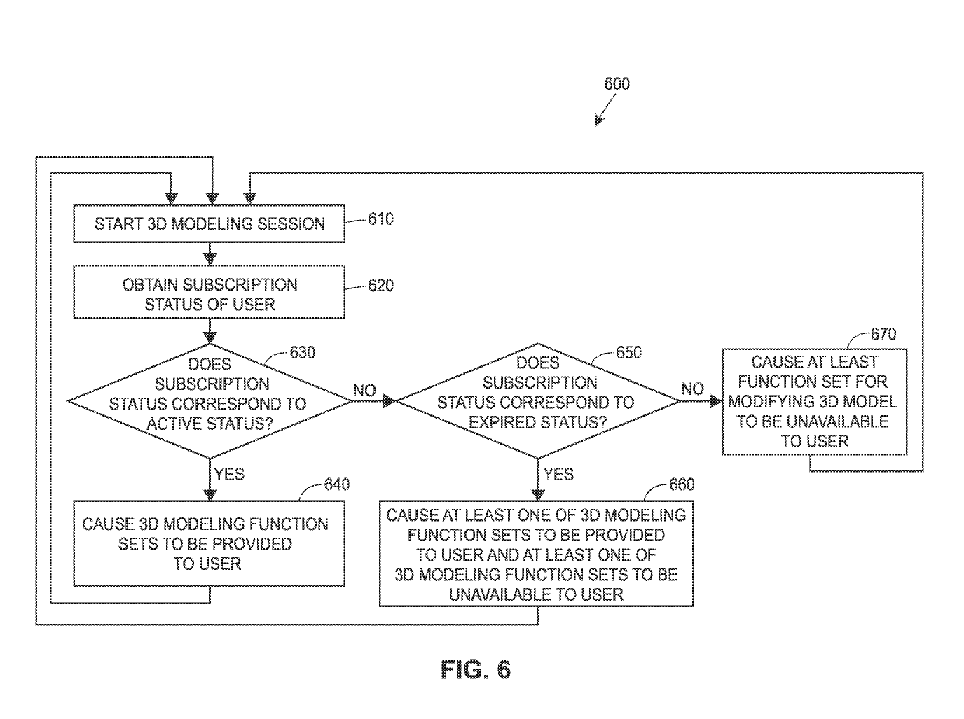

FIG. 6 is a flow diagram of another example method 600 for controlling 3D modeling features based on a user's subscription status including a post-expiration period (e.g., where a user may be associated with an active trial subscription status, an expired trial subscription status, or an expired post-trial period subscription status). The method 600 of the flow diagram illustrated in FIG. 6 may be implemented in one or more servers, such as the server 120 of FIG. 1, or in a user's computing device such as the user computer 130 of FIG. 1, and will be described with reference to FIG. 1 for illustrative purposes. The method 600 may, however, be implemented by other suitable computing devices. In some embodiments, the method of FIG. 6 may be stored as instructions that are a part of a 3D modeling software application, such as the 3D modeling software application 180 of FIG. 1.

At block 610, a 3D modeling session is started. From the perspective of the user computer 130, the start of the 3D modeling session may in some embodiments occur in response to a user entering one or more commands via a UI of the user computer 130. For example, the start of the 3D modeling session may represent the launching of the 3D modeling software application 180 in response to a user command to start the application 180. As another example, the start of the 3D modeling session may represent a user working on (e.g., viewing and/or modifying) a second 3D model using the application 180 after having worked on a first 3D model using the application 180, where the new session begins in response to the user selecting the second 3D model. From the perspective of the server 120, the start of the 3D modeling session may represent the reception of a data message (e.g., a data message received from the user computer 130 via the communication network 140) that indicates or requests permission for the launching of the 3D modeling software application 180 and/or a user's attempt to begin working on a second 3D model, for example.

At block 620, a subscription status of a user is obtained. The subscription status of the user may be obtained in a manner similar to that described above in connection with block 340 of FIG. 3, for example.

At block 630, it is determined whether the subscription status obtained at block 620 corresponds to an active status. For example, the server 120 or the user computer 130 may execute instructions for determining whether the user subscription status 166 corresponds to an active status. If it is determined that the subscription status obtained at block 620 corresponds to an active status, the flow proceeds to block 640. If it is determined that the subscription status obtained at block 620 does not correspond to an active status, the flow proceeds to block 650.

At block 640, 3D modeling function sets including function sets for creating, viewing, and modifying 3D models are caused to be provided to the user in response to determining at block 630 that the user's subscription status corresponds to an active status. In some embodiments, the 3D modeling functions sets also include a function set for exporting a 3D model to a different software application, and/or a function set for collaboratively developing a 3D model with a different user at a different computing device. The 3D modeling function sets may be caused to be provided to the user in a manner similar to that described above in connection with block 240 of FIG. 2, for example. Subsequent to the block 640, the flow proceeds back to block 610, where the process of the method 600 repeats in response to the start of a new 3D modeling session. In some embodiments, the flow may instead proceed to block 620 after a predetermined length of time, i.e., the steps of blocks 620, 630 and beyond may repeat periodically while a 3D modeling session is in effect, without requiring that the user end a first 3D modeling session and begin a second 3D modeling session.

At block 650, it is determined whether the subscription status obtained at block 620 corresponds to an expired status. For example, the server 120 or the user computer 130 may execute instructions for determining whether the user subscription status 166 corresponds to an expired status. If it is determined that the subscription status obtained at block 620 corresponds to an expired status, the flow proceeds to block 660. If it is determined that the subscription status obtained at block 620 does not correspond to an expired status, the flow proceeds to block 670.

At block 660, at least one of the 3D modeling function sets is again caused to be provided to the user, and at least one other of the 3D modeling function sets is caused to be made unavailable to the user, in response to determining at block 650 that the user's subscription status corresponds to an expired status. In the example embodiment of FIG. 6, however, the function set for modifying 3D models is not among the one or more function sets caused to be made unavailable to the user at block 660. The 3D modeling function sets may be caused to be provided or made unavailable to the user in a manner similar to that described above in connection with block 280 of FIG. 2, for example. Subsequent to the block 660, the flow proceeds back to block 610, where the process of the method 600 repeats in response to the start of a new 3D modeling session. In some embodiments, the flow may instead proceed to block 620 after a predetermined length of time, i.e., the steps of blocks 620, 630 and beyond may repeat periodically while a 3D modeling session is in effect, without requiring that the user end a first 3D modeling session and begin a second 3D modeling session.

At block 670, at least the function set for modifying 3D models is caused to be made unavailable to the user, in response to determining at block 650 that the user's subscription status does not correspond to an expired status (e.g., in response to determining at block 660 that the user's subscription status corresponds to a second expired status, such as an expired post-trial period). The function set for modifying 3D models may be caused to be made unavailable to the user in a manner similar to that described in connection with block 280 of FIG. 2, for example. Subsequent to the block 670, the flow proceeds back to block 610, where the process of the method 600 repeats in response to the start of a new 3D modeling session. In some embodiments, the flow may instead proceed to block 620 after a predetermined length of time, i.e., the steps of blocks 620, 630 and beyond may repeat periodically while a 3D modeling session is in effect, without requiring that the user end a first 3D modeling session and begin a second 3D modeling session.

FIG. 7 is a flow diagram of an example method 700 for providing 3D modeling features to a user based on permissions data. The method 700 of the flow diagram illustrated in FIG. 7 may be implemented in a user's computing device, such as the user computer 130 of FIG. 1, and will be described with reference to FIG. 1 for illustrative purposes. The method 700 may, however, be implemented by other suitable computing devices. In some embodiments, the method of FIG. 7 may be stored as instructions that are a part of a 3D modeling software application, such as the 3D modeling software application 180 of FIG. 1.

At block 710, a 3D modeling session is started. In some embodiments, the start of the 3D modeling session occurs in response to a user entering one or more commands via a UI of the user's computing device. For example, the start of the 3D modeling session may represent the launching of the 3D modeling software application 180 in response to a user command to start the application 180. As another example, the start of the 3D modeling session may represent a user working on (e.g., viewing and/or modifying) a second 3D model using the application 180 after having worked on a first 3D model using the application 180, where the new session begins in response to the user selecting the second 3D model.

At block 720, permissions data is requested. For example, the 3D modeling software application 180 may generate the request in response to the start of the 3D modeling session at block 710. As a more specific example, the application 180 may automatically generate an HTTP request in response to the start of the 3D modeling session, before a user is granted access to some or all 3D modeling functionality of the application 180. In some embodiments, the request is generated only after the user enters user identification/authentication information such as a login and/or password. The HTTP request itself may include user identification/ authentication information, such as the user's name, login, or login and password, for example. As another example, the HTTP request may include a cookie stored in the user computer 130. The identification/authentication information may in some embodiments include the user ID 164 of the user profile data 162, for example, or other information that the server 120 may use to identify the user ID 164. The HTTP request may also include a message indicating that the user wishes to launch the 3D modeling software application 180, for example. As another example, the HTTP request may also include a message indicating that the user wishes to start working on a different 3D model. In some embodiments, the application 180 may cause the user computer 130 to transmit the request to the server 120 via the communication network 140. The user computer 130 may transmit the request via a network interface of the user computer 130, for example.

At block 730, permissions data is received. For example, the permissions data may be received by the user computer 130 from the server 120 via the communication network 140. The user computer 130 may receive the permissions data via a network interface of the user computer 130, for example. The server 120 may have transmitted the permissions data to the user computer 130 in response to the request (at block 720) for permissions data, for example. In some embodiments, the received permissions data may be stored in a persistent memory of a user's computing device (e.g., the data storage 176). The permissions data may be similar to the permissions data discussed above in connection with FIGS. 1 and 2, for example.

At block 740, 3D model data is requested. For example, the 3D modeling software application 180 may generate a request for the 3D model data 150. In some embodiments, the request may be generated in response to a user action. For example, the request may be generated in response to the user of the application 180 selecting a 3D model from a list of previously edited 3D models, where the selected 3D model corresponds to the 3D model data 150. As another example, the request may be generated in response to a user clicking on a link in a web page stored in a persistent memory of a web page server, where the link identifies a 3D model that corresponds to the 3D model data 150. The request for the 3D model data 150 may be an HTTP request, for example. The HTTP request may include user identification/ authentication information, such as the user's name, login, login and password, or a cookie stored in the user computer 130. The identification/authentication information may in some embodiments include the user ID 154 of the metadata 152 associated with the 3D model data 150. The HTTP request may also include a message indicating that the user wishes to obtain the 3D model data 150, for example. In some embodiments, the application 180 may cause the user computer 130 to transmit the request via the communication network 140 to a server including the 3D model storage 110. The user computer 130 may transmit the request via a network interface of the user computer 130, for example.

At block 750, 3D model data is received. For example, the 3D model data 150 may be received by the user computer 130 via the communication network 140 from a server that includes the 3D model storage 110 (e.g., the server 120). The user computer 130 may receive the 3D model data 150 via a network interface of the user computer 130, for example. The server may have transmitted the 3D model data 150 to the user computer 130 in response to the request (at block 740) for 3D model data, for example. In some embodiments, the received 3D model data may be stored in a persistent memory of a user's computing device (e.g., the data storage 176).

At block 760, 3D modeling function sets corresponding to the permissions data received at block 730 are provided to the user, thereby allowing the user to work with the 3D model represented by the 3D model data received at block 750. For example, the 3D modeling software application 180 may provide the 3D modeling function sets in a manner similar to that discussed above in connection with block 240 of FIG. 2, allowing the user to work with the 3D model represented by the 3D model data 150. In some embodiments, the permissions data includes additional data indicating that certain 3D modeling function sets should be made available only for 3D models meeting certain criteria. For example, the permissions data may include data indicating that certain function sets (e.g., a function set for modifying 3D models) should be made unavailable to a user with respect to 3D models that were not created by the user, regardless of subscription status. To that end, in some embodiments, the functionality of the application 180 may depend on metadata of the 3D model data received at block 750. For example, the application 180 may make a function set for modifying 3D models unavailable to a particular user if the user ID 154 in the metadata 152 of the 3D model data 150 does not correspond to the user (even if, for example, the user currently has an active subscription). As another example, the permissions data may include data indicating that certain function sets should be made unavailable to a user with respect to 3D models that were not created by the user during an active subscription period of that user. For example, the application 180 may make a function set for modifying 3D models unavailable to a particular user if the user ID 154 in the metadata 152 of the 3D model data 150 does not correspond to the user, or if the time stamp 156 does not correspond to an active subscription period of that user.

FIG. 8 is a flow diagram of an example method 800 for controlling 3D modeling features by generating permissions data corresponding to a user subscription status. The method 800 of the flow diagram illustrated in FIG. 8 may be implemented in one or more servers, such as the server 120 of FIG. 1, and will be described with reference to FIG. 1 for illustrative purposes. The method 800 may, however, be implemented by other suitable computing devices.

At block 820, a request for permissions data is received. For example, the server 120 may receive the request from the user computer 130 via the communication network 140. The server 120 may receive the permissions data via a network interface of the server 120, for example. The request may be similar to the request discussed above in connection with block 720, for example.

At block 840, a subscription status of a user is determined. For example, the server 120 may determine the user subscription status 166. To identify the appropriate user, the server 120 may process identification/authentication information included in the request received at block 820, for example. For example, the server may learn the user ID 164 based on identification/authentication information in the request that is similar to the identification/authentication information discussed above in connection with block 720 of FIG. 7. In some embodiments, the subscription status is determined by determining whether conditions corresponding to an active subscription status currently exist. For example, the server 120 may determine whether the user subscription status 166 corresponds to an active or an expired status by determining whether the user had previously selected an option (e.g., by using a GUI of a web browser executing on the user computer 130) indicating that the user agreed to terms of service for a subscription. As another example, the server 120 may determine whether the subscription status 166 corresponds to an active or expired status by determining whether the user had previously selected an option indicating that the user agreed to terms of service for a subscription and that a predetermined length of time has not expired. In some embodiments, the subscription status is determined by retrieving the subscription status from an external source. For example, the server 120 may determine the user subscription status 166 by retrieving the user subscription status 166 from another server. In some embodiments, the subscription status is determined in response to receiving the request at block 820. In other embodiments, the subscription status is determined prior to receiving the request for permissions data at block 820.

At block 860, permissions data is generated. For example, the server 120 may generate permissions data by comparing the user subscription status 166 determined at block 840 to correlation data representing correlation information such as the correlation information illustrated in the example embodiment of FIG. 4. The correlation data may be stored in a persistent memory of the server 120 or may be retrieved from an external source (e.g., another server on the communication network 140), for example. The permissions data may be similar to the permissions data discussed above in connection with FIGS. 1 and 2, for example. In some embodiments, the generated permissions data is stored in a persistent memory of a server. For example, the generated permissions data may be stored in a persistent memory of the server 120 (e.g., as a part of the user profile data 162 in the user profile storage 160).

At block 880, the permissions data generated at block 860 is caused to be transmitted to a user's computing device. For example, the server 120 may cause a network interface of the server 120 to transmit the permissions data to the user computer 130 via the communication network 140.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for progressively providing software components for browser-based 3D modeling through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for controlling features of a 3D modeling software application, the method comprising:
automatically determining, at a first time, that a subscription status of a user corresponds to an active status;
in response to determining that the subscription status corresponds to the active status, causing an inspection function, a modification function, and a creation function to be provided, via an interface of a computing device, to the user for activation, wherein:
the inspection function is for interpreting existing modeling data to view a corresponding existing 3D model,
the modification function is for modifying the existing modeling data to modify the corresponding existing 3D model, and
the creation function is for creating new modeling data that corresponds to a new 3D model;
the method further comprising:
automatically determining, at a second time subsequent to the first time, that the subscription status of the user corresponds to an expired status; and
in response to determining that the subscription status corresponds to the expired status:
causing at least one of the inspection function, the modification function, and the creation function to be provided to the user for activation, and
causing at least a different one of the inspection function, the modification function, and the creation function to be made unavailable to the user at the computing device.

2. The method of claim 1, including, in response to determining that the subscription status corresponds to the expired status:
causing the inspection function and the modification function to be provided to the user for activation; and
causing the creation function to be made unavailable to the user.

3. The method of claim 2, further comprising:
automatically determining, at a third time subsequent to the second time, that a selected 3D model was not created by the user; and
in response to determining that the selected 3D model was not created by the user, causing the modification function to be made unavailable to the user for use with the selected 3D model.

4. The method of claim 2, wherein the expired status is a first expired status; the method further comprising:
automatically determining, at a third time subsequent to the second time, that the subscription status corresponds to a second expired status; and
in response to determining that the subscription status corresponds to the second expired status, causing the modification function to be made unavailable to the user.

5. The method of claim 4, wherein:
determining that the subscription status corresponds to the first expired status includes determining that a first predetermined subscription time has expired; and
determining that the subscription status corresponds to the second expired status includes determining that a second predetermined subscription time has expired.

6. The method of claim 1, wherein determining that the subscription status corresponds to the active status includes at least one of (i) determining that the user has selected an option indicating agreement to terms of service and (ii) determining that a predetermined subscription time has not expired.

7. The method of claim 1, further comprising:
automatically determining, at a first intermediate time subsequent to the first time and prior to the second time, that the user operated on a threshold number of 3D models using the 3D modeling software application; and
in response to determining that the user operated on a threshold number of 3D models using the 3D modeling software application, causing the creation function set to be made unavailable to the user.

8. The method of claim 1, further comprising:
automatically determining, at a time subsequent to the first time, that the user has exceeded a threshold amount of memory allocated for storing 3D models; and
in response to determining that the user has exceeded the threshold amount of memory, causing the creation function to be made unavailable to the user.

9. The method of claim 1, further comprising:
in response to determining that the subscription status corresponds to the active status, causing an exporting function to be provided, via the interface of the computing device, to the user for activation, wherein the exporting function is for exporting the 3D model to a second software application, and
in response to determining that the subscription status corresponds to the expired status, causing the exporting function to be made unavailable to the user at the computing device.

10. The method of claim 1, further comprising:
in response to determining that the subscription status corresponds to the active status, causing a collaborative development function to be provided, via the interface of the computing device, to the user for activation, wherein the collaborative development function is for developing a 3D model in real-time collaboration with another user operating another computing device, and
in response to determining that the subscription status corresponds to the expired status, causing the collaborative development function to be made unavailable to the user at the computing device.

11. The method of claim 1, wherein:
determining that the subscription status corresponds to the active status includes transmitting a first request to a server storing a user profile that includes the subscription status, and
determining that the subscription status corresponds to the expired status includes transmitting a second request to the server.

12. The method of claim 1, wherein:
causing the inspection function, the modification function, and the creation function to be provided to the user includes causing first permissions data to be transmitted over a communication network, and
causing one of the inspection function, the modification function, and the creation function to be made unavailable to the user includes causing second permissions data to be transmitted over a communication network.

13. A tangible non-transitory computer-readable medium having stored thereon a plurality of instructions for controlling features of a 3D modeling software application, including instructions for:
determining, at a first time, that a subscription status of a user corresponds to an active status;
in response to determining that the subscription status corresponds to the active status, causing an inspection function, a modification function, and a creation function to be provided, via an interface of a computing device, to the user for activation, wherein:
the inspection function is for interpreting existing modeling data to view a corresponding existing 3D model,
the modification function is for modifying the existing modeling data to modify the corresponding existing 3D model, and
the creation function is for creating new modeling data that corresponds to a new 3D model;
determining, at a second time subsequent to the first time, that the subscription status of the user corresponds to an expired status; and
in response to determining that the subscription status corresponds to the expired status:
causing at least one of the inspection function, the modification function, and the creation function to be provided to the user for activation, and
causing at least a different one of the inspection function, the modification function, and the creation function to be made unavailable to the user at the computing device.

14. The computer-readable medium of claim 13, wherein each of the plurality of instructions is interpretable by a web browser application.

15. The computer-readable medium of claim 13, wherein each of the plurality of instructions is compiled.

16. A method implemented in a server for controlling access of a user to features of a 3D modeling software application executing on one or more processors of a computing device that is communicatively coupled to the server by a communication network, the method comprising:
receiving via the communication network a first request for permissions data;
automatically determining, at a first time, that a subscription status of the user corresponds to an active status; and
in response to receiving the first request and determining that the subscription status corresponds to the active status, causing first permissions data to be transmitted to the computing device via the communication network, wherein
the first permissions data causes the 3D modeling software application to provide, via an interface of the computing device, an inspection function, a modification function, and a creation function to the user for activation,
the inspection function is for interpreting existing modeling data to view a corresponding existing 3D model,
the modification function is for modifying the existing modeling data to modify the corresponding existing 3D model, and
the creation function is for creating new modeling data that corresponds to a new 3D model;
the method further comprising:
receiving via the communication network a second request for permissions data;
automatically determining, at a second time subsequent to the first time, that the subscription status of the user corresponds to an expired status; and
in response to receiving the second request and determining that the subscription status corresponds to the expired status, causing second permissions data to be transmitted to the computing device via the communication network, wherein the second permissions data causes the 3D modeling software application to:
provide to the user for activation at least one of the inspection function, the modification function, and the creation function, and
make unavailable to the user at the computing device at least a different one of the inspection function, the modification function, and the creation function.

17. The method of claim 16, wherein:
causing the first permissions data to be transmitted to the computing device includes generating the first permissions data based on the subscription status of the user and correlation data; and
causing the second permissions data to be transmitted to the computing device includes generating the second permissions data based on the subscription status of the user and the correlation data.

18. The method of claim 16, wherein receiving the first request includes receiving the first request from the computing device, and wherein receiving the second request includes receiving the second request from the computing device.

19. The method of claim 16, wherein the server stores a plurality of user profiles, and wherein the plurality of user profiles includes a first user profile that includes the subscription status.

20. The method of claim 16, wherein the expired status is a first expired status, the method further comprising:
receiving via the communication network a third request for permissions data;
automatically determining, at a third time subsequent to the second time, that the subscription status of the user corresponds to a second expired status; and
in response to receiving the third request and determining that the subscription status corresponds to the second expired status, causing third permissions data to be transmitted to the computing device via the communication network, wherein the third permissions data causes the 3D modeling software application to make unavailable to the user at the computing device at least a second different one of the inspection function, the modification function, and the creation function.
